(19) United States
(12) Patent Application Publication
(10) Pub. No.: US 2023/0228954 A1
(43) Pub. Date: Jul. 20, 2023

(54) COUPLER AND METHOD FOR PRODUCING A COUPLER

(71) Applicant: HUBER+SUHNER Cube Optics AG, Mainz (DE)

(72) Inventors: Thomas PETIGK, Rüsselsheim (DE); Ingo SMAGLINSKI, Mainz (DE)

(73) Assignee: HUBER+SUHNER Cube Optics AG, Mainz (DE)

(21) Appl. No.: 18/097,617

(22) Filed: Jan. 17, 2023

(30) Foreign Application Priority Data
Jan. 19, 2022 (DE) 102022101222.0

(51) Int. Cl. G02B 6/42; F21V 8/00

(52) U.S. Cl. CPC G02B 6/4239; G02B 6/0031; G02B 6/4259; G02B 6/4255; G02B 6/4266

(57) ABSTRACT

Coupler for coupling or decoupling a light signal into or out of a front face of a fibre optic having a fibre optic comprising an end portion with a front face, as well as a moulded part made of optically transparent material, wherein the end portion of the fibre optic is arranged in the moulded part and is connected to the moulded part in a positively locking manner. Furthermore, a method for producing a coupler for coupling or decoupling a light signal into or out of a front face of a fibre optic, has the following steps:
A) providing a mould with a mould space,
B) inserting an end portion of a fibre optic having the front face into the mould space,
C) filling the mould space with an optically transparent material in flowable form,
D) solidifying the optically transparent material into a moulded part.

The present invention relates to a coupler for coupling or decoupling a light signal into or out of a front face of a fibre optic as well as a method for producing such a coupler.

In particular, in communications technology, fibre optics, also known as fibre optic cables, are used in order to transmit signals over long distances. Therefore, optical signals must be coupled into the fibre optic at the beginning of the transmission link and decoupled from the fibre optic at the end of the transmission link. The couplers mentioned above are used for this pur-pose.

With the proliferation of the so-called Terabit Ethernet, in particular, the requirements for the accuracy of the couplers are also increasing over larger temperature ranges. It is particularly important that the front face of the fibre optic in which the optical signal is being coupled or decoupled is positioned at the correct position relative to an optical element. Hollow mirror-like optical elements are often used here, so that a beam of light exiting the front face of the fibre optic is directed towards a corresponding detector or lattice coupler for evaluating the optical signal.

The exact position of the fibre optic is effort-intensive. In addition, there is a risk that the positioning will no longer be optimal when the ambient temperature is changed.

Proceeding from the described prior art, the problem addressed by the present invention is thus to specify an easily manufacturable coupler that allows for a simple and exact positioning of the fibre optic.

According to the invention, this problem is achieved in that the coupler comprises a moulded part made of optically transparent material as well as a fibre optic, wherein an end portion of the fibre optic is arranged with the front face in the moulded part such that the end portion is connected to the moulded part in a material-locking manner.

In other words, the end portion of the fibre optic is retained by the moulded part, with the result that the fibre optic is optimally positioned relative to the moulded part. For example, it is possible to arrange the end portion such that the moulded part envelops the end portion.

For example, the moulded part can consist of a first adhesive. An adhesive is best used here which cures by introducing energy, e.g. by means of UV radiation. It is therefore possible to insert the end portion of the fibre optic into the mould in which the moulded part is produced before the adhesive is added or cured.

The coupler according to the invention is suitable for coupling or decoupling a light signal. When coupling the light signal, a corresponding light signal must be generated and mapped to the front face of the fibre optic. When decoupling, the light beam exiting the front face must be directed towards a detector. In the following description of the invention, only the variant in which a light signal is decoupled from the fibre optic is described. However, it is understood that the same coupler could also be used in order to couple a light signal when the propagation direction of the light signal is reversed.

Thus, in a preferred embodiment, a beam of light exiting the fibre optic via the front face defines an optical axis, wherein the moulded part comprises a surface that is inclined opposite the optical axis, which surface is arranged such that a beam of light exiting the fibre optic from the front face meets the inclined surface, wherein the inclined surface is configured such that the beam of light is reflected.

The light beam exiting the front face is thus guided within the moulded part and meets an inclined reflective surface, which provides for a deflection of the light beam exiting the front face. In a particularly preferred embodiment, the inclined surface is additionally curved and namely preferably curved such that the beam of light exiting the front face of the fibre optic is focused on substantially one point or one surface by the curved surface.

For example, the reflective property of the transparent material can be caused by the transparent material being embedded in a material consisting of a thinner material and the curved surface being arranged such that, upon impact of the light beam on the curved surface, the boundary angle of total reflection is exceeded. The optically thinner material can also be ambient air. Alternatively, the outer side of the inclined surface can be coated with a reflective material.

In a further preferred embodiment, it is provided that the fibre optic comprises a fibre optic core as well as a sheath portion surrounding the fibre optic core, wherein the moulded part comprises a recess, wherein the recess engages not with an intended extension of the sheath portion beyond the front face but rather with an intended extension of the fibre optic core beyond the front face, wherein the recess preferably has a wall, which is partially formed by the front face of the fibre optic, or the front face can be optically detected by the wall.

With this measure, after curing of the transparent material, it can checked with the naked eye whether the fibre optic is correctly positioned within the transparent material. The recess is configured so as not to influence the light signals exiting the fibre optic core.

Furthermore, the moulded part can have at least a partially triangular cross-section, wherein the end portion abuts two sides of the triangular cross-section. This measure also serves to check with the naked eye whether the end portion is correctly positioned within the moulded part.

In a further preferred embodiment, a plurality of couplers of the aforementioned type are provided. Such a multi-coupler is provided for parallel coupling or decoupling multiple light signals in or out of front faces of multiple fibre optics.

For example, the multi-coupler could comprise four couplers, such that four fibre optics are coupled. Preferably, mono-mode fibre optics are used.

In a further preferred embodiment, the plurality of couplers is arranged on a common base plate, wherein the base plate is preferably transparent and is particularly preferably a glass plate. It is then only necessary to align the base plate relative to the detectors, because the couplers are already aligned on the base plate. The signal guidance can be carried out through the base plate. The base plate can either be transparent if it is made of glass, for example, or it can have a hole, through which the light signal is passed.

In addition, a cover plate can be provided, which is arranged opposite to the base plate such that the coupler is arranged between the base plate and the cover plate, wherein the cover plate is preferably a glass plate. With this embodiment, the couplers are arranged between the cover plate and the base plate in a protected manner.

In a further preferred embodiment, a second adhesive, preferably a glass-filled adhesive, is arranged between the couplers and is in contact with at least two couplers arranged adjacent to one another.

With this measure, adjacent couplers are connected to one another so that—apart from thermal expansions—they can no longer be moved relative to one another. If a glass-filled adhesive is used and a glass plate is used as the base plate as well as the cover plate, the thermal expansion coefficients of the two plates as well as the glass-filled adhesive are relatively well matched to one another. A temperature change therefore does not result in a misalignment of the coupler.

A glass-filled adhesive is understood to mean an adhesive in which fibre optic optics or glass beads are incorporated.

With respect to the method, the problem mentioned above is solved by a method for producing a coupler for coupling or decoupling a light signal in or out of a front face of a fibre optic, comprising the following steps:
A) providing a mould with a mould space,
B) inserting an end portion of a fibre optic having the front face into the mould space,
C) filling the mould space with an optically transparent material in flowable form,
D) solidifying the optically transparent material into a moulded part.

The mould thus forms the negative mould corresponding to the moulded part. The shape of the mould space corresponds to the shape of the moulded part to be produced. An end portion of a fibre optic is first inserted into this mould space, and the mould space is then filled with the optically transparent material in flowable form. Thereafter, the flowable, transparent material is solidified.

For example, the mould space could be filled using an injection moulding process. The solidification can then be achieved by cooling the heated and pressurized melt. Alternatively, the optically transparent material can also consist of a first adhesive, which is cured in the mould, preferably using UV light.

In a preferred embodiment, it is provided that a layer of reflective material is introduced at least partially into the mould space before step C). For example, a thin gold layer could be applied. The gold layer then functions both as a debonding agent to facilitate demoulding of the optically transparent material from the mould as well as serving as a reflective layer.

In principle, the moulded part can remain in the mould. The mould is then a so-called lost mould. Preferably, however, in one embodiment, the moulded part is removed from at least a portion of the mould after the solidification of the transparent material in a step E), so that at least this part of the mould can be reused.

In a further particularly preferred embodiment, in step A), a mould with a stop element is provided and, in step B), the end portion of the fibre optic is placed in the mould space in such a way that a portion of the front face of the fibre optic abuts the stop element.

Such a stop element simplifies positioning of the front face of the fibre optic within the mould space. This feature according to the invention makes use of the fact that the signal transmission within the fibre optic only takes place in the fibre optic core, whereas no signal transmission takes place in the much larger sheath portion. The stop element can therefore be configured so as to only cover the sheath portion of the fibre optic at the front face while not standing in the way of the fibre optic core. Because the stop element is part of the mould, the moulded part has a recess after demoulding, the dimensions of which correspond to the dimensions of the stop element.

In a further preferred embodiment, the mould space has a substantially V-shaped groove into which the end portion is inserted such that the end portion comes to rest on the two walls of the V-shaped groove. A passive positioning of the end portion within the mould is thus possible.

In a further preferred embodiment, it is provided that in step A), a mould having multiple mould spaces is provided; in step B), an end portion of a fibre optic is inserted into each mould space; and in step C), each mould space is filled with an optically transparent material in flowable form. In other words, multiple couplers are produced using a single mould. It is also possible to interconnect the mould spaces such that the couplers are fixed at a defined distance from one another and the plurality of couplers form a multi-coupler.

In a further preferred embodiment, it is provided that all moulded parts are positioned on a base plate, which is preferably formed as a glass plate. It is possible to fix the individual moulded parts on the base plate. This can be done, for example, using an adhesive. It is also possible to fix the individual moulded parts on the base plate prior to step E), so that the individual moulded parts maintain the distance defined by the mould relative to one another. A complex alignment of the individual moulded parts to one another is no longer necessary.

In a further preferred embodiment, the base plate is used as part of the mould so that the optically transparent material cures while in contact with the base plate, such that the moulded part(s) are already positioned in the correct position on the base plate. In this case, the base plate cannot be reused as part of the mould, but instead becomes part of the coupler.

In a preferred embodiment, it is provided that an adhesive is applied to the base plate between the moulded parts. This adhesive need not be the same adhesive used as the optically transparent material of the moulded parts.

The relative position between the moulded parts is permanently fixed by the adhesive arranged between the moulded parts.

In a preferred embodiment, it is provided that the second adhesive in its cured state preferably has an expansion coefficient that is less than the expansion coefficient of the optically transparent material or the first adhesive. For example, the second adhesive can be a glass-filled adhesive. This measure ensures that the multi-coupler remains aligned even in case of major temperature fluctuations.

In a further preferred embodiment, it is provided that a cover plate, preferably a cover plate made of glass, is positioned on the moulded parts so that the moulded parts are arranged between the base plate and the cover plate. The moulded parts are therefore protected from above and from below by the base plate and the cover plate, respectively. The base plate, the cover plate, and the moulded parts located therebetween thus form a multi-coupler, which can be aligned as a whole relative to corresponding detectors. Any alignment of the moulded parts to one another is no longer necessary. In addition, in case of temperature fluctuations, there is no significant de-alignment.

In a further preferred embodiment, it is provided that a plate consisting of a material having a thermal expansion behaviour that is different than the thermal expansion behaviour of the optically transparent material used in step C) is used as the base plate, and that the ambient temperature is set before and preferably also during step D) in order to adjust the spacing between adjacent moulded parts. For example, if the thermal expansion coefficient of the optically transparent material used in step C) is greater than the expansion coefficient of the material of the base plate, the spacing between adjacent moulded parts on the base plate can be increased by raising the ambient temperature prior to the solidification in step D).

In another preferred embodiment, it is provided that a plate consisting of a material having a thermal expansion behaviour that is different than the thermal expansion behaviour of the material of the mould used in step A) is used as the base plate, and that the ambient temperature is set before and preferably also during step D) in order to adjust the spacing between adjacent moulded parts. For example, if the thermal expansion coefficient of the material of the form used in step A) is greater than the expansion coefficient of the material of the base plate, the spacing between adjacent moulded parts on the base plate can be increased by raising the ambient temperature prior to the solidification in step D).

Further advantages, opportunities, and possible applications will become apparent from the following description of a preferred embodiment and the associated figures. Here:

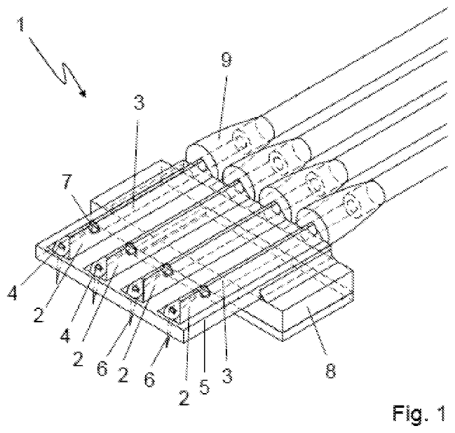

FIG. 1 shows a schematic perspective view of a first embodiment of a multi-coupler according to the present invention,

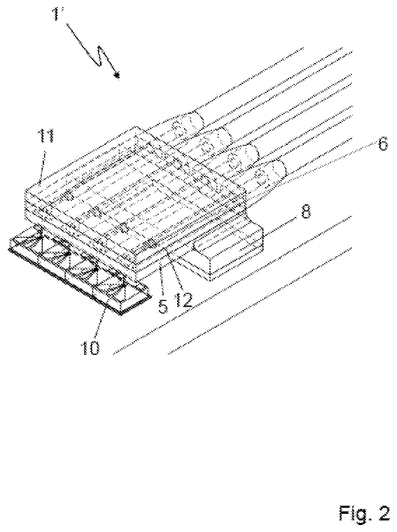

FIG. 2 shows a schematic perspective view of a second embodiment of a multi-coupler according to the present invention, and

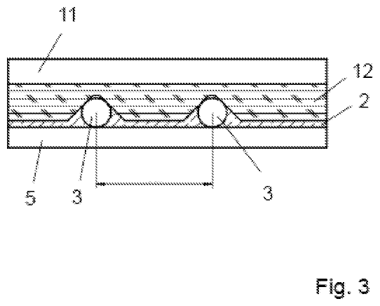

FIG. 3 shows a partial sectional view through the embodiment of FIG. 2.

In FIG. 1, a perspective view of a first embodiment of a multi-coupler 1 is shown. The multi-coupler 1 comprises a plurality, namely four in the embodiment shown, base bodies 2 made of a transparent material, and the same number of fibre optics 3. Each fibre optic 3 is arranged in a base body 2 so that a light signal 6 exiting the front face 13 is guided within the base body 2, which consists of a transparent material.

The fibre optics 3 are each fixedly connected to the respective base body 2. In the embodiment shown, the transparent material of the base body 2 completely encloses an end portion of the fibre optic 3. On the side of the fibre optic 3 facing away from the base body 2, a kink protection device 9 is provided. Each base body 2 has a curved surface 4, which is positioned such that a beam of light exiting the front face 13 of the fibre optic 3, which is schematically visualized by correspondingly drawn cones 6 in FIG. 1, meets the curved surface 4 and is reflected and focused by it.

Each base body 2 has a recess 7. A wall of recess 7 is partially formed by the front face 13 of the fibre optic 3. The recess 7 is dimensioned and the front face 13 of the fibre optic 3 is positioned in such a way that a fibre optic core of the fibre optic 3 does not terminate at the wall of the recess 7. The signal transmission within fibre optics 3 takes place exclusively within a fibre optic core, which only occupies a small part of the cross-sectional surface of the fibre optic 3. Because the recess 7 does not occlude the fibre optic core, it is ensured that light signals from the recess 7 can exit the front face 13 of the fibre optics 3 uninfluenced and can reach the curved surface 4. The base bodies 2 are formed partially with a triangular cross-section so that the end portion of the fibre optic 3 abuts two walls of the triangular shape.

All base bodies 2, including the embedded end portions of the fibre optics 3, are positioned on a base plate 5 and fixed therein, which, in the embodiment shown, is made of a transparent material, namely glass. This has the advantage that the light signal can be guided through the base plate 5, and the spacing of the generated focal points shifts only with the low expansion coefficient of the glass upon a temperature change. If the base plate 5 is not made of a transparent material, it can have corresponding holes through which the light signal 6 can pass.

Because all base bodies 2 have been produced together in a mould (not shown), the distances of the base body 2 relative to one another are defined by the mould. An alignment of the base bodies 2 relative to one another is therefore generally not necessary. However, the distance between the base bodies 2 can be changed by a targeted temperature change when the material solidifies.

The base plate 5 can, as can be seen in FIG. 1, be mounted on a spacing element 8, e.g. glued, which in turn is fixedly connected to a corresponding printed circuit board (not shown), on which, for example, detectors are located that detect the signal exiting the front face 13 of the fibre optic 3 and reflected and focused on the curved surface 4.

FIG. 2 shows a second embodiment of a multi-coupler 1′ according to the invention. In FIG. 2, the same reference numbers were used for the same components, insofar as possible.

The embodiment shown in FIG. 2 differs from the embodiment shown in FIG. 1 in that, on the one hand, an adhesive 12 is provided between the base bodies 2, which surrounds the base bodies 2, and, on the other hand, a cover plate 11 is provided. The individual base bodies 2 are thus arranged between the base plate 5 and the cover plate 11. If a glass-filled adhesive is used as the adhesive 12 and both the base plate 5 and the cover plate 11 are configured as a glass plate, it is ensured that there is no de-alignment or misalignment of the individual base bodies 2 in relation to one another or with respect to height.

In FIG. 2, the detectors 10 are additionally shown. It can be seen that the light beams 6 exiting the front faces 13 are reflected on the curved surfaces and focused on the detectors 10.

Finally, FIG. 3 shows a partial cross-sectional view of the embodiment of FIG. 2.

Two end portions of fibre optics 3 can be seen, which are embedded in a moulded part 2 consisting of the first adhesive in such a way that they contact both the glass plate 5 and the walls of moulded part portions with a triangular cross-section. Because the corresponding mould in which the moulded part 2 is produced [sic]

Furthermore, the cover plate 11 can be seen, as well as the second adhesive 12, which is arranged between the moulded part 2 and the cover plate 11.

### LIST OF REFERENCE NUMBERS

1, 1′ Multi-coupler
2 Base body
3 Fibre optic
4 Curved surface
5 Base plate
6 Light signal
7 Recess
8 Spacing element
9 Kink protection device
10 Detectors
11 Cover plate
12 Adhesive
13 Front face

1. A coupler for coupling or decoupling a light signal into or out of a front face of a fibre optic having a fibre optic comprising an end portion with a front face, as well as a moulded part made of optically transparent material, wherein the end portion of the fibre optic is arranged in the moulded part and is connected to the moulded part in a positively locking manner.

2. The coupler according to claim 1, wherein the moulded part consists of a first adhesive, preferably a cured first adhesive.

3. The coupler according to 1, wherein a beam of light exiting the fibre optic via the front face defines an optical axis, wherein the moulded part comprises a surface that is inclined opposite the optical axis, which surface is arranged such that a beam of light exiting the fibre optic from the front face meets the inclined surface, wherein the inclined surface is configured such that the beam of light is reflected, wherein the inclined surface is preferably curved and particularly preferably curved such that the beam of light exiting the front face of the fibre optic is focused on a point by the curved surface.

4. The coupler according to claim 3, wherein the inclined surface is coated with a reflective material on its outer side.

5. The coupler according to 1, wherein the fibre optic comprises a fibre optic core as well as a sheath portion surrounding the fibre optic core,
wherein the moulded part comprises a recess,
wherein the recess engages not with an intended extension of the sheath portion beyond the front face but rather with an intended extension of the fibre optic core beyond the front face, and
wherein the recess preferably has a wall, which is partially formed by the front face of the fibre optic, or the front face can be optically detected by the wall.

6. The coupler according to claim 1, wherein the moulded part has at least a partially triangular cross-section, wherein the end portion abuts two sides of the triangular cross-section.

7. A multi-coupler for parallel coupling or decoupling multiple light signals in or out of front faces of a plurality of fibre optics, having a plurality of couplers according to claim 1.

8. The multi-coupler according to claim 7, wherein the plurality of couplers are arranged on a common base plate, wherein the base plate is preferably transparent and is particularly preferably a glass plate.

9. The multi-coupler according to claim 8, wherein a cover plate is provided, which is arranged opposite to the base plate such that the coupler is arranged between the base plate and the cover plate, and
wherein the cover plate is preferably a glass plate.

10. The multi-coupler according to claim 7, wherein between the couplers, a second adhesive is arranged, which is in contact with at least two adjacently arranged couplers, and
wherein the second adhesive in its cured state preferably has an expansion coefficient that is less than the expansion coefficient of the optically transparent material.

11. A method for producing a coupler for coupling or decoupling a light signal into or out of a front face of a fibre optic, comprising the following steps:
A) providing a mould with a mould space,
B) inserting an end portion of a fibre optic having the front face into the mould space,
C) filling the mould space with an optically transparent material in flowable form, and
D) solidifying the optically transparent material into a moulded part.

12. The method according to claim 11 wherein in step D), the solidification takes place by cooling or hardening the transparent material.

13. The method according to claim 11, wherein before step C), a layer of reflective material is introduced at least partially into the mould space.

14. The method according to claim 11, wherein the following occurs after step D):
E) demoulding the moulded part from at least a portion of the mould.

15. The method according to claim 11, wherein in step A), a mould with a stop element is provided and, in step B), the end portion of the fibre optic is placed in the mould space in such a way that a portion of the front face of the fibre optic abuts the stop element.

16. The method according to claim 11, wherein in step A), a mould having multiple mould spaces is provided; in step B), an end portion of a fibre optic is inserted into each mould space; and in step C), each mould space is filled with an optically transparent material in flowable form.

17. The method according to claim 16, wherein all moulded parts are positioned on a base plate, which is preferably configured as a glass plate.

18. The method according to claim 16, wherein the following occurs after step D):
E) demoulding the moulded part from at least a portion of the mould, and
wherein a base plate, which is preferably configured as a glass plate, is used as part of the mould, so that after step D), the moulded parts are positioned on the base plate and in step E), the moulded parts are not demoulded from the base plate.

19. The method according to claim 18, wherein a cover plate, preferably a glass cover plate, is positioned on the moulded parts so that the moulded parts are arranged between the base plate and the cover plate.

20. The method according to claim 18, wherein a plate consisting of a material having a thermal expansion behaviour that is different than the thermal expansion behaviour of the material of the mould used in step C) is used as the base plate, and that the ambient temperature is set before and preferably also during step D) in order to adjust the spacing between adjacent moulded parts.
